(19) United States
(12) Patent Application Publication
(10) Pub. No.: US 2026/0346699 A1
(43) Pub. Date: Nov. 5, 2026

(54) ELECTRIC WHEEL HUB DRIVE

(71) Applicant: MERCEDES-BENZ GROUP AG, Stuttgart (DE)

(72) Inventors: Michael SCHMIDT, Wernau (DE); Arthur ADAM, Sindelfingen (DE); Fabian SCHWED, Esslingen am Neckar (DE); Johannes DEHN, Hochdorf (DE); Jessica ROOSZ, Esslingen (DE)

(21) Appl. No.: 19/136,589

(22) PCT Filed: Nov. 17, 2023
(86) PCT No.: PCT/EP2023/082238

§ 371 Date: Jun. 6, 2025

(30) Foreign Application Priority Data
Dec. 7, 2022 (DE) 10 2022 004 588.5

(51) Int. Cl. B60K 7/00; B60K 17/02

(52) U.S. Cl. CPC B60K 7/0007; B60K 17/02; B60K 2007/0038; B60K 2007/0092

(57) ABSTRACT

An electric wheel hub drive for a motor vehicle includes a wheel carrier, a wheel bearing with a first bearing ring non-rotatably connected to the wheel carrier and a second bearing ring arranged so as to be rotatable with respect to a main rotational axis, an electric engine having a stator carrier which is non-rotatably connected to the wheel carrier, and a rotor carrier connected to the rotor for conjoint rotation and mounted so as to be rotatable with respect to the wheel carrier. A decoupler has a first coupling half connected to the rotor carrier for conjoint rotation and a second coupling half connected to the second bearing ring for conjoint rotation. The first coupling half of the decoupler is arranged on an outer bearing shell of a rotor bearing so as to be axially displaceable.

### BACKGROUND AND SUMMARY OF THE INVENTION

Exemplary embodiments of the invention relate to an electric wheel hub drive.

A decoupler (disconnect unit) can be used in an electric wheel hub drive for a motor vehicle. This can have a sliding sleeve, which requires a suitable bearing surface.

Electric wheel hub drives are known for example from JP 2020-128134 A1 and DE 10 2022 000 035 A1.

US 2020/0287495 A1 describes a control device for an electric motor having a first set of coil windings, which are arranged to form a first sub-motor, and a second set of coil windings, which are arranged to form a second sub-motor, wherein the current flow in the first set of coil windings is controlled using a first pulse-width modulation (PWM) with a first switching sequence and the current flow in the second set of coil windings is controlled using a second PWM with a second switching sequence, wherein the control device comprises means arranged to measure the current flow in each of the first set of coil windings, wherein after determining that the sum of the current flow in the first set of coil windings is substantially not zero, the first PWM values are deduced from voltage values are deduced which are used to create the second PWM.

Exemplary embodiments of the invention are directed to a novel electric wheel hub drive.

In the context of the present application, the term “for conjoint rotation” is used as follows: Two elements are connected to each other for conjoint rotation when they are arranged coaxially to each other (in relation to their rotational axis or in relation to an axis of rotational symmetry) and when they are connected to each other in such a way that they always rotate at the same angular velocity. An element is non-rotatably connected to a housing when it cannot be rotated relative the housing.

In the context of the present application, the term “radially overlapping” is used as follows: Two (in particular substantially rotationally symmetrical) elements are arranged radially overlapping in relation to a common axis when they are each at least partially arranged in a region of the same radial coordinates (specifically and of the same angular coordinates).

In the context of the present application, the term “axially overlapping” is used as follows: Two elements are arranged axially overlapping with regard to a common axis when they are each at least partially arranged in a region of the same axial coordinates.

In the context of the present application, the term “radially inside” is used as follows: A first element is arranged radially inside a second element, in relation to a common axis, when the first element is arranged in a region of smaller radii than the second element.

According to the invention, an electric wheel hub drive for a motor vehicle is proposed, having a wheel carrier, having a wheel bearing which has a first bearing ring non-rotatably connected to the wheel carrier and a second bearing ring arranged so as to be rotatable with respect to a main rotational axis, having an electric engine which has a stator and a rotor arranged so as to be rotatable around the main rotational axis, having a stator carrier non-rotatably connected to the wheel carrier, having a rotor carrier connected to the rotor for conjoint rotation and mounted so as to be rotatable with respect to the wheel carrier. According to the invention, a decoupler is provided, which has a first coupling half connected to the rotor carrier for conjoint rotation and a second coupling half connected to the second bearing ring for conjoint rotation, wherein the first coupling half is arranged to be axially displaceable in relation to an outer bearing shell of a rotor bearing. According to the invention, the first coupling half is arranged radially surrounding and at least partially axially overlapping the outer bearing shell of the rotor bearing. The outer bearing shell of the rotor bearing is also referred to as a third bearing ring in the following.

In one embodiment, an axial displacement device is provided that is designed to axially displace the first coupling half, wherein the axial displacement device has a pinion arranged axially between the first coupling half and the wheel carrier.

In one embodiment, the pinion is arranged radially overlapping the first coupling half, which means at least partially in a region of the same radii.

In one embodiment, the axial displacement device has a first ramp ring coupled to the pinion via a tooth engagement and a second ramp ring connected to the stator carrier via a groove of the stator carrier for conjoint rotation, wherein the ramp rings are arranged axially adjacent to each other and have respective ramps, which are designed and engaged with each other in such a way that rotation of the first ramp ring with respect to the second ramp ring causes axial displacement of the second ramp ring.

In one embodiment, a servomotor is provided that is arranged on a side of the wheel carrier facing away from the first and second coupling half, wherein a shaft is connected to a rotor of the servomotor for conjoint rotation and to the pinion for conjoint rotation.

In one embodiment, the second ramp ring is connected to a shift fork for conjoint rotation, which engages into a groove of the first coupling half.

In one embodiment, a return spring acting parallel to the main rotational axis is provided, which is arranged in such a way that on the one hand it is supported on the second ramp ring, on the other hand is directly or indirectly supported on the rotor carrier.

In one embodiment, a rotational axis of the servomotor is arranged parallel to the main rotational axis.

In one embodiment, the wheel carrier has a drilled hole, wherein the shaft is guided through the drilled hole.

In one embodiment, a cover is provided which is arranged over the servomotor on the side thereof facing away from the wheel.

A decoupler in the meaning of the present invention comprises two coupling halves (for example, as a claw coupling or form-fitting coupling; alternatively, a multiple-disc coupling or a frictional coupling may also be used). Furthermore, the term “decoupler” can include a sliding sleeve formed with the first coupling half, wherein the second coupling half of the decoupler is advantageously connected directly to the brake disc carrier for conjoint rotation or is formed by this. The second coupling half can, however, also be designed as a separate claw toothing which is also connected to the second bearing ring for conjoint rotation.

The term “actuator of the decoupler” includes all components mounted upstream of the first coupling half: servomotor, adjustment shaft, pinion, axial displacement device (having the pinion, a first ramp ring, a second ramp ring, if necessary, with balls lying in between).

Advantageously, the function of the bearing surface for the first coupling half is integrated in the rotor bearing, so that little additional installation space is required. Therefore, the outer surface of the rotor bearing can simultaneously form the bearing surface for the first coupling half. In this manner, weight, cost and installation space are saved.

Exemplary embodiments of the invention are explained in more detail in the following using the drawings.

### BRIEF DESCRIPTION OF THE DRAWING FIGURES

In the figures:

FIG. 1 shows a schematic view of an electric wheel hub drive for a motor vehicle, and

FIG. 2 shows a schematic detailed view of the electric wheel hub drive.

Parts corresponding to one another are provided with the same reference numerals in all the figures.

### DETAILED DESCRIPTION

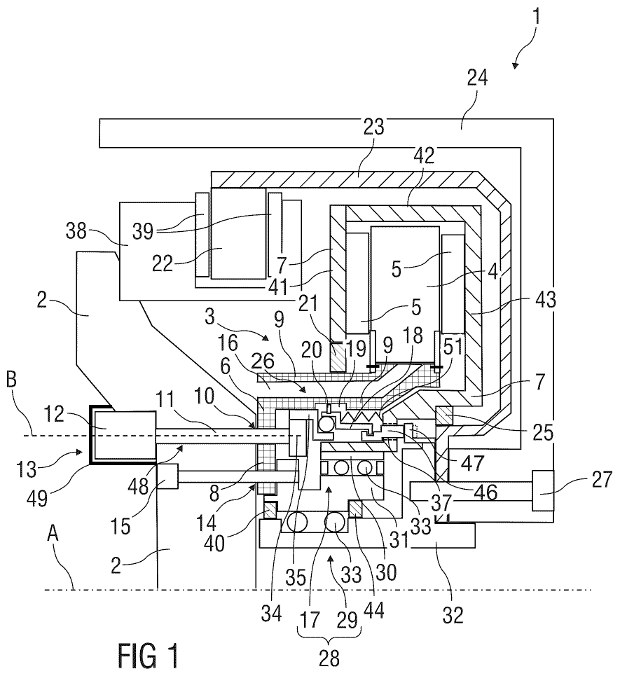

FIG. 1 shows a schematic view of an electric wheel hub drive 1 for a motor vehicle, having a wheel carrier 2, an electric engine 3 having a stator 4 and a rotor 5 arranged so as to be rotatable around a main rotational axis A, a stator carrier 6 non-rotatably connected to the wheel carrier 2, a rotor carrier 7 connected to the rotor 5 for conjoint rotation and mounted so as to be rotatable with respect to the wheel carrier 2. The stator carrier 6 has a disc section 8 and a cylinder section 9. The cylinder section 9 is arranged radially outside the disc section 8. The disc section 8 has a first passage 10 for a shaft 11 of a servomotor 12 of a decoupler 13, which is arranged radially inside the cylinder section 9.

In one embodiment, the disc section 8 has second passages 14 for screw connections 15, which are designed to connect the disc section 8 to the wheel carrier 2 for conjoint rotation.

In one embodiment, the second passages 14 are substantially arranged in a region of the same radii as the first passage 10.

In one embodiment, the cylinder section 9 has at least one channel 16 designed for receiving a coolant.

In one embodiment, a rotor bearing 17 for rotationally bearing the rotor 5 is provided and is arranged radially inside and axially overlapping the channel 16.

In one embodiment, the decoupler 13 furthermore has a second ramp ring 18 arranged radially inside the cylinder section 9. The ramp ring 18 is connected to the cylinder section 9 for conjoint rotation and can be displaced axially with respect to the cylinder section 9.

In one embodiment, the cylinder section 9 has at least one groove 19 on its radially inner side, which groove runs parallel to the main rotational axis A. The ramp ring 18 is connected to at least one pin 20, which each engage into one of the grooves 19.

In one embodiment, the cylinder section 9 has a sealing surface on its radially outer side for a seal 21, in particular a radial seal, with respect to the rotor carrier 7.

In one embodiment, the sealing surface is arranged axially between the stator 4 and a brake disc 22.

The rotor bearing 17 is a part of a combined bearing 28, which further includes a wheel bearing 29. The combined bearing 28 has a third bearing ring 30 designed as an outer bearing shell, a first bearing ring 31 designed as a central bearing shell, and a second bearing ring 32 designed as an inner bearing shell. A plurality of rolling elements 33 is arranged between the third bearing ring 30 (the outer bearing shell) and the first bearing ring 31 (the central bearing shell), which bearing rings form the rotor bearing 17. A plurality of rolling elements 33 is arranged between the first bearing ring 31 (the central bearing shell) and the second bearing ring 32 (the inner bearing shell), which bearing rings form the wheel bearing 29.

The brake disc 22 can be designed as an inside-out brake disc and can be arranged on a brake disc carrier 23 connected to a wheel rim 24 for conjoint rotation. The wheel rim 24 and the brake disc carrier 23 are connected to the second bearing ring 32 (the inner bearing shell) of the wheel bearing 29 via several wheel screws 27 for conjoint rotation.

A further radial seal 25 can be arranged between the brake disc carrier 23 and the rotor carrier 7.

The ramp ring 18 is connected to a first coupling half 46, which is mounted to be axially displaceable in a respective passage 37 in the rotor carrier 7 and is designed for optional engagement with a second coupling half 47. The second coupling half 47 is connected to the second bearing ring 32 of the wheel bearing 29 for conjoint rotation.

Advantageously, the first coupling half 46 is arranged to be axially displaceable and also radially surrounding and at least partially axially overlapping the third bearing ring 30 designed as an outer bearing shell of the rotor bearing 17.

Particularly advantageously, the rotor carrier 7 has a ring section arranged radially surrounding and axially overlapping the third bearing ring 30. The third bearing ring is directly connected to the ring section for conjoint rotation. Advantageously, the first coupling half 46 is mounted directly on the ring section with a plain bearing.

Advantageously, the second coupling half 47 is directly connected to the brake disc carrier 23 for conjoint rotation, which in turn is advantageously connected directly to the second bearing ring 32 for conjoint rotation.

A pinion 34 is also arranged on the shaft 11, which is connected to the second ramp ring 18 via a first ramp ring 35 with teeth.

Furthermore, a brake caliper 38 with brake pads 39 is arranged on the wheel carrier 2. The brake caliper 38 can be designed as an internal brake caliper 38.

The wheel carrier 2, the brake caliper 38, the brake pads 39, the stator 4, the stator carrier 6, the servomotor 12, the shaft 11, the pinion 34, and the first bearing ring 31 do not rotate with the wheel rim 24.

The brake disc 22, the brake disc carrier 23 and the second bearing ring 32 always rotate together with the wheel rim 24.

The rotor carrier 7, the rotor 5, the first coupling half 46, and the third bearing ring 30 (the outer bearing shell) only rotate with the wheel rim 24 when the decoupler 13 is engaged, i.e., when the first coupling half 46 is connected to the second coupling half 47 for conjoint rotation.

The electric engine 3 can be designed as an axial flux machine.

To seal a rotor space, in particular an intermediate space between the rotor 5 and the stator 4, a first seal 21 can be provided, which is arranged coaxially to the rotor carrier 7 in such a way that a first intermediate gap is filled by the first seal 21 between the rotor carrier 7 and the stator carrier 6.

A second seal 25 or further radial seal 25 can be arranged coaxially to the rotor carrier 7 in such a way that a second intermediate gap is filled by the second seal 25 between the rotor carrier 7 and the brake disc carrier 23.

With regard to the main rotational axis A, the second seal 25 can be arranged axially on a side of the first seal 21, facing away from the wheel carrier 2.

The second seal 25 can be arranged radially inside the stator 4, which means in particular radially inside the region of magnets arranged in the stator 4.

The first seal 21 can be arranged radially inside the rotor 5, which means in particular radially inside the region of magnets arranged in the rotor 5.

A first connection point for connecting the brake disc carrier 23 to the second bearing ring 32 can be arranged radially inside the second seal 25.

The brake disc 22, which is connected to the brake disc carrier 23 for conjoint rotation, can be arranged on a side of the first seal 21 opposite the second seal 25, axially with regard to the main rotational axis A.

A third seal 40 can furthermore be arranged coaxially to the rotor carrier 7 in such a way that a third intermediate gap is filled by the third seal 40 between the central bearing shell, or rather the first bearing ring 31, and the inner bearing shell, or rather the second bearing ring 32.

Furthermore, there may be a second connection point for the sealed connection of the first bearing ring 31 to the stator carrier 6. Thus, the rotor space is closed: the stator carrier 6 has the cylinder section 9, which is sealed by means of the first seal 21 with respect to a first disc-shaped part 41 of the rotor carrier 7, which lies on one side of the stator 4 when viewed axially. The rotor carrier 7 furthermore has a cylindrical part 42 and a second disc-shaped part 43 connected to the cylindrical part 42 and sealed with respect to the brake disc carrier 23 by means of the second seal 25. The brake disc carrier 23 has a sealed connection point for connection to the second bearing ring 32 (the inner bearing shell). The second bearing ring 32 (the inner bearing shell) is sealed with respect to the first bearing ring (the central bearing shell) by means of the third seal 40. The first bearing ring 31 has the sealed second connection point for connection to the stator carrier 6.

A fourth seal 44 can furthermore be provided between the second bearing ring 32 and the first bearing ring 31 on the side of the wheel bearing 29 that is axially opposite the third seal 40.

The first bearing ring 31 can be designed as a single, integral bearing shell, which forms both a radially outer bearing ring of the wheel bearing 29 and also a radially inner bearing ring of the rotor bearing 17. Alternatively, the first bearing ring 31 can also be designed as two bearing shells (or bearing rings), connected to each other for conjoint rotation, of which one is a radially outer part of the wheel bearing 29 and the other is a radially inner part of the rotor bearing 17.

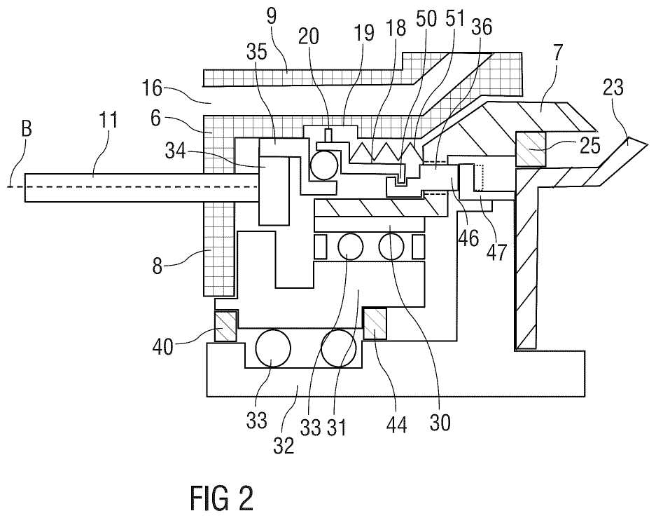

FIG. 2 is a schematic detailed view of the electric wheel hub drive 1.

The decoupler 13 has the first coupling half 46 connected to the rotor carrier 7 for conjoint rotation.

The first coupling half advantageously comprises a sliding sleeve.

The decoupler 13 furthermore comprises the second coupling half 47 connected to the second bearing ring 32 for conjoint rotation. The second coupling half 47 is thus also connected to the wheel rim 24 for conjoint rotation.

A servomotor 12 of the decoupler 13 is advantageously arranged directly on the wheel carrier 2. A cover 49 of the servomotor 12, which functions as a housing of the servomotor 12, is advantageously fixed to the wheel carrier 2 using screws. The servomotor 12 is advantageously arranged on a side of the wheel carrier 2 facing away from the first and second coupling halves 46, 47, wherein the servomotor 12 advantageously protrudes at least partially into a cavity in the wheel carrier 2.

A rotational axis B of the shaft 11 can be arranged parallel to the main rotational axis A.

The shaft 11 is connected to a servomotor rotor of the servomotor 12 for conjoint rotation. Advantageously, the wheel carrier 2 has a drilled hole 48 through which the shaft 11 is guided. The drilled hole 48 can be aligned with the passage 10.

The disc section 8 is advantageously arranged on a side of the wheel carrier 2 facing away from the servomotor 12. The disc section 8 has the passage 10 through which the shaft 11 is guided.

Advantageously, an axial displacement device 26 is arranged on a side of the wheel carrier 2 facing away from the servomotor 12, which device is designed to convert a rotational movement of the shaft 11 into an axial movement parallel to the main rotational axis A.

The axial displacement device 26 has the pinion 34, which is connected to the shaft 11 for conjoint rotation.

The axial displacement device 26 furthermore has the first ramp ring 35, coupled to the pinion 34 via a tooth engagement, and the second ramp ring 18, connected to the stator carrier 6 via the groove 19 of the stator carrier 6 for conjoint rotation.

Advantageously, the first ramp ring 35 and the second ramp ring 18 are arranged radially inside the cylinder section 9 and axially overlapping this. Particularly advantageously, the entire axial displacement device 26 is arranged radially inside the cylinder section 9 and axially overlapping this.

The second ramp ring 18 has a shift fork 50, which engages into a groove of the first coupling half 46.

The first coupling half advantageously penetrates one or more passages 37 in the rotor carrier 7, whereby the first coupling half 46 is also connected to the rotor carrier 7 for conjoint rotation, so that the first coupling half 46 can rotate together with the rotor carrier 7, while the second ramp ring 18 does not rotate. The first coupling half can, however, be moved axially together with the second ramp ring 18.

Rotation of the shaft 11 causes rotation of the first ramp ring 35 via the pinion 34 and the toothing, thereby causing axial movement of the second ramp ring 18 and the first coupling half 46. Depending on the rotational direction of the shaft 11, the first coupling half engages or disengages accordingly into or from the second coupling half 47 and thus couples the rotor carrier 7 to the brake disc carrier 23 or decouples the rotor carrier 7 from the brake disc carrier 23.

The cover 49 is furthermore arranged over the servomotor 12.

The first coupling half 46 is arranged circularly in the region of engagement of the shift fork 50 and coaxially to the main rotational axis A. Advantageously, the first coupling half has a claw toothing, which can be engaged with a corresponding claw toothing of the second coupling half 47 on a side of the rotor carrier 7 facing away from the shift fork.

Advantageously, the first bearing ring 31 also forms a radially inner bearing ring of the rotor bearing 17, wherein the radially outer bearing ring of the rotor bearing 17 (specifically the third bearing ring 30) is connected to the rotor carrier 7 for conjoint rotation.

Furthermore, a return spring 51 acting parallel to the main rotational axis A can be provided, which is arranged in such a way that on the one hand it is supported on the second ramp ring 18, on the other hand it is supported on the rotor carrier 7.

The components of the decoupler 13 which are mounted upstream of the first coupling half 46, i.e., the servomotor 12, the shaft 11, the pinion 34 and the axial displacement device 26 (having the pinion 34, the first ramp ring 35, the second ramp ring 18, if necessary, balls lying between the ramp rings 35, 18), together can be referred to as an actuator.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 electric wheel hub drive
2 wheel carrier
3 electric engine
4 stator
5 rotor
6 stator carrier
7 rotor carrier
8 disc section
9 cylinder section
10 passage
11 shaft
12 servomotor
13 decoupler
14 passage
15 screw connection
16 channel
17 rotor bearing
18 ramp ring
19 groove
20 pin
21 seal, first seal
22 brake disc
23 brake disc carrier
24 wheel rim
25 further radial seal, second seal
26 axial displacement device
27 wheel screw
28 combined bearing
29 wheel bearing
30 third bearing ring
31 first bearing ring
32 second bearing ring
33 rolling elements
34 pinion
35 ramp ring
37 passage
38 brake caliper
39 brake pad
40 third seal
41 first disc-shaped part
42 cylindrical part
43 second disc-shaped part
44 fourth seal
46 first coupling half
47 second coupling half
48 drilled hole
49 cover
50 shift fork
51 return spring
A main rotational axis
B rotational axis

1-10. (canceled)

11. An electric wheel hub drive for a motor vehicle, the electric wheel hub drive comprising:
a wheel carrier;
a wheel bearing comprising a first bearing ring non-rotatably connected to the wheel carrier and a second bearing ring arranged so as to be rotatable with respect to a main rotational axis;
an electric engine comprising a stator and a rotor, wherein the rotor arranged so as to be rotatable around the main rotational axis;
a stator carrier non-rotatably connected to the wheel carrier;
a rotor carrier connected to the rotor to conjointly rotate and mounted so as to be rotatable with respect to the wheel carrier;
a rotor bearing;
a third bearing ring formed as an outer bearing shell of the rotor bearing;
a decoupler comprising a first coupling half connected to the rotor carrier to conjointly rotate and a second coupling half connected to the second bearing ring to conjointly rotate, wherein the first coupling half is axially displaceable and is arranged radially surrounding and at least partially axially overlapping the third bearing ring; and
an axial displacement device configured to axially displace the first coupling half, wherein the axial displacement device has a pinion, which is arranged axially between the first coupling half and the wheel carrier.

12. The electric wheel hub drive of claim 11, wherein the pinion is arranged radially overlapping the first coupling half.

13. The electric wheel hub drive of claim 11, wherein the axial displacement device comprises
a first ramp ring coupled to the pinion via a tooth engagement; and
a second ramp ring non-rotatably connected to the stator carrier via a groove of the stator carrier,
wherein the first and second ramp rings are arranged axially adjacent to each other and have respective ramps configured to engage with each other in such a way that rotation of the first ramp ring with respect to the second ramp ring causes axial displacement of the second ramp ring.

14. The electric wheel hub drive of claim 11, further comprising:
a servomotor arranged on a side of the wheel carrier facing away from the first and second coupling half; and
a shaft connected to a rotor of the servomotor to conjointly rotate and to the pinion to conjointly rotate.

15. The electric wheel hub drive of claim 13, wherein the second ramp ring has a shift fork engaging into a groove of the first coupling half.

16. The electric wheel hub drive of claim 13, further comprising:
a return spring acting parallel to the main rotational axis, wherein the return spring is configured so that the return spring is supported on the second ramp ring and is supported on the rotor carrier.

17. The electric wheel hub drive of claim 14, wherein a rotational axis of the servomotor is arranged parallel to the main rotational axis.

18. The electric wheel hub drive of claim 14, wherein the wheel carrier has a drilled hole, wherein the shaft is guided through the drilled hole.

19. The electric wheel hub drive of claim 14, further comprising:
a cover arranged over the servomotor on the side thereof facing away from the wheel carrier.
